(19) United States
(12) Patent Application Publication
(10) Pub. No.: US 2011/0296945 A1
(43) Pub. Date: Dec. 8, 2011

(54) PEDAL SET FOR VIDEO GAMES OR DRIVING SIMULATION

(75) Inventors: Jean-Yves Jaouen, Saint Jean La Poterie (FR); Patrick Pennaneac'h, Chateaubourg (FR); David Sauvage, Mordelles (FR); Gilles Raulet, Vannes (FR)

(73) Assignee: GUILLEMOT CORPORATION, Chantepie (FR)

(21) Appl. No.: 13/152,671

(22) Filed: Jun. 3, 2011

(30) Foreign Application Priority Data
Jun. 3, 2010 (FR) 1054375
Oct. 27, 2010 (FR) 1058863

(51) Int. Cl. G05G 1/44

(52) U.S. Cl. 74/512

(57) ABSTRACT

The invention concerns a pedal set (100) for video games or vehicle driving simulation, the pedal set (100) comprising a frame (102) and a pedal (116) which has the ability to move in rotation with respect to the frame (102), the pedal (116) having a supporting areas for a foot. The pedal set (100) being characterised insofar as the frame (102) is designed to take alternatively at least two stable positions on the floor or a support: an initial position, in which seen from the left of the pedal set (100), the pedal (116) pivots anticlockwise under the force produced by the foot; and a second position, in which seen from the left of the pedal set (100), the pedal (116) pivots clockwise under the force produced by the foot. The supporting area of the pedal (116) is, in each position, laid out in such a way as to be positioned roughly at the level of the metatarsal of the foot.

### BACKGROUND

1. Field of the Invention

The field of the invention is that of interactive leisure equipment and accessories for computers and games consoles. More specifically, this invention concerns a pedal set for video games or for driving simulation, a part comprising fastening means for the pedal set, and a process for changing the position of the pedal set.

2. Background

Some video games implement a simulated vehicle that runs in a simulated environment. A pedal set for video games comprises at least one pedal that can be used with a video game, for example, to simulate control of the acceleration, brake or clutch of a land motor vehicle (especially a car). A pedal set can also be used in addition to a joystick to control the movement of an aircraft (usually an aeroplane or helicopter).

A pedal set for video games comprises a frame that is positioned on the floor and contains several pedals. Each pedal has a lever arm, which has the ability to move in rotation with respect to the frame and a pedal set head which is attached to the free end of the lever arm. For certain pedal sets, the level arm and the pedal set head form a single part.

Each pedal comprises means of detection that make it possible to detect when the pedal is activated. The means of detection then transmit the information related to displacement of the pedal to a central unit, for example a computer or games console, to interact with the video game itself installed in the central unit.

There exist pedal sets in which the rotational axis is at the lower end of the level arm.

There exist other pedal sets in which the rotational axis is at the upper end of the lever arm. The pedals are then suspended.

Depending on the video game used, it is preferable to use one position or the other. However, the player must then have two types of pedal set, which is restrictive.

The user of the pedal set (player, learner, etc.) wants to get as close as possible to reality. Therefore he must use different types of pedal sets according to the applications and requirements. Thus, for a video game simulating vehicle driving, the use of a pedal set corresponding in shape and use to the type of vehicle being driven makes the simulation more realistic, for example, the use of a pedal set with the shape and position of the pedals of a grand tourer car for a grand tourer car racing game and the use of a pedal set for which the rotational axis of the lever arm is at the lower end of the lever arm for a Formula 1 racing game.

Having two types of pedal set is expensive and poses the problem of storing them and therefore a problem of clutter.

### SUMMARY OF THE INVENTION

One of the purposes of this invention is to propose a pedal set for video games that does not present the disadvantages of the prior art and that in particular allows a realistic simulation so that the movement of the pedals corresponds to the movement of the pedals of the simulated vehicle for any type of vehicle simulated.

The invention also has the purpose, according to at least one embodiment, of providing a pedal set for video games or driving simulation that is safe, simple to install and easy to use.

The invention also has the purpose, according to at least one embodiment, of providing a pedal set for video games or driving simulation that is adaptable to the body type of the user.

The invention also has the purpose, according to at least one embodiment, of providing a pedal set for video games or driving simulation that is easy to store and carry.

To this effect, a pedal set for video games or vehicle driving simulation is proposed, said pedal set comprising:

a frame, and

at least one pedal which has the ability to move in rotation on the frame, this pedal or each pedal having a supporting area for at least one foot,

said pedal set being characterised in that said frame is designed to take alternatively at least two stable positions on the floor or a support:

a first stable position, in which seen from the left of the pedal set, said or each pedal pivots anticlockwise under the force produced by said at least one foot to activate the pedal

a second stable position, in which seen from the left of the pedal set, said or each pedal pivots clockwise under the force produced by said at least one foot to activate the pedal

the supporting area of the pedal or each pedal being, in each stable position, laid out in such a way as to be positioned roughly at the level of the metatarsal of said at least one foot.

Advantageously, said frame is made up of a first part that supports the pedal or pedals and at least a second part, this or each second part being attached, in a way that can be detached, to the first part or another of the second parts.

Advantageously, said frame is made up of a first part that supports the pedal or pedals and at least a second part, this or each second part having the ability to move in rotation with respect to the first part or with respect to another of the second parts.

Advantageously, there is only one first part and only one second part, which are fitted together in an L-shape, and the pedal supporting areas are laid out inside the branches of the L.

Advantageously, the rotation is carried out by a hinge between the first part and the second part or each of the second parts.

Advantageously, the pedal set comprises at least one spacer fastened, in a way that can be detached, between the two parts to hold them in position with respect to each other.

Advantageously, each part has a positioning side, each one being designed to be positioned on the ground or on a support and each one corresponding to a stable position of the pedal set.

Advantageously, the pedal set comprises a selector allowing reassignment of at least one of the pedals according to the position of the pedal set.

Advantageously, the selector is a gravity detector.

Advantageously, the pedal set comprises, for the pedal or each pedal, an intermediate adjustment device intended to allow angular adjustment of the pedal, this intermediate adjusting device comprises a clevis with the ability to move in rotation with respect to the frame, an adjustment axis which is mobile in rotation with respect to the clevis and locking means that lock the position of the pedal with respect to the clevis, with this locking means taking the form of a retractable pin set on the pedal, and a series of at least two holes made in the clevis and intended to receive the retractable pin.

Advantageously, the pedal or each pedal is made up of a lever arm, a pedal head comprising the supporting area and an intermediate adjusting mechanism attached, on one side, to the lever arm and, on the other side attached to the pedal head and intended to adjust the pedal head with respect to the lever arm.

Advantageously, the pedal set comprises for the pedal or each pedal, a stop attached to the frame, in a way that can be detached, and comprising a stop area against which the pedal comes to a stop when it is activated by the at least one foot or when the stop pre-stresses the pedal.

Advantageously, the position of this stop can be adjusted so as to allow movement of the stop area along the length of the pedal.

The invention also proposes a second part comprising means of attachment to a first part of a pedal set according to a previous variant.

The invention also includes a process for changing the position of a pedal set according to one of the previous variants and this process comprises:

a step where the pedal set pivots around an axis that is roughly parallel to the rotational axis of the or each pedal so as to change from one stable position to the other stable position, and

a step where the function of the pedal or at least one of the pedals is reassigned.

Advantageously, the process for changing position also comprises a step where the pedal set pivots around an axis that is roughly at right angles to the surface of the floor or the pedal set support.

### BRIEF DESCRIPTION OF THE DRAWINGS

The characteristics of the invention mentioned above, and others, will be revealed more clearly on reading the following description of an example of operation. This description is given in conjunction with the appended drawings, among which:

FIG. 1 represents a pedal set for video games according to a first embodiment of the invention in a first user position;

FIG. 2 represents the pedal set of FIG. 1 in a second user position with a footplate and a footrest;

FIG. 3 shows the attachment of a springback system for the pedal set;

FIG. 4 shows a detail drawing of FIG. 3;

FIG. 5 shows a mechanism for adjusting the pedal head;

FIG. 6 shows the pedal set according to the invention;

FIG. 7 shows a detail drawing of the pedal set according to the invention;

FIG. 8 shows the pedal set according to the invention seen from the left;

FIG. 9 represents a pedal set for video games according to a second embodiment of the invention in a first user position;

FIG. 10 represents the pedal set in FIG. 9 in a second user position;

FIG. 11 shows a vertical cross-section of the pedal set from FIG. 9; and

FIG. 12 shows another vertical cross-section of the pedal set from FIG. 10.

### DETAILED DESCRIPTION

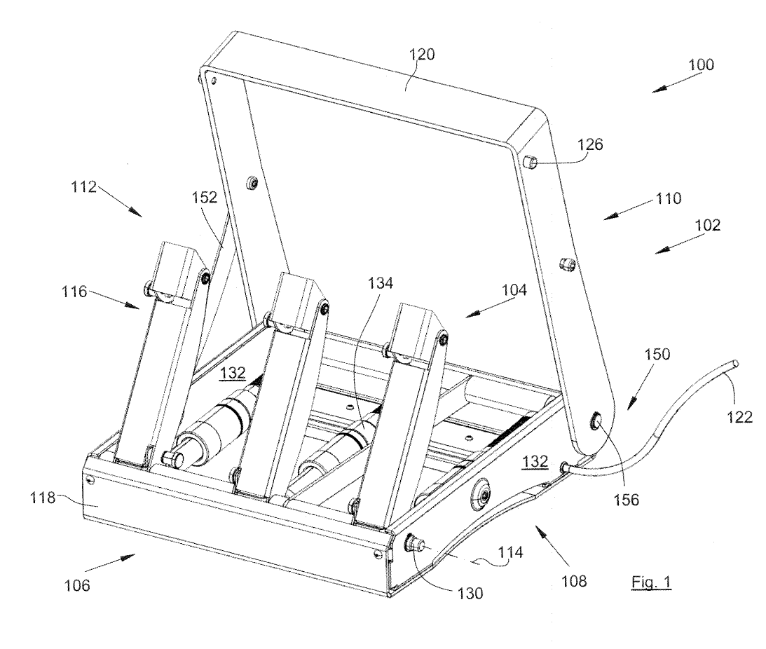

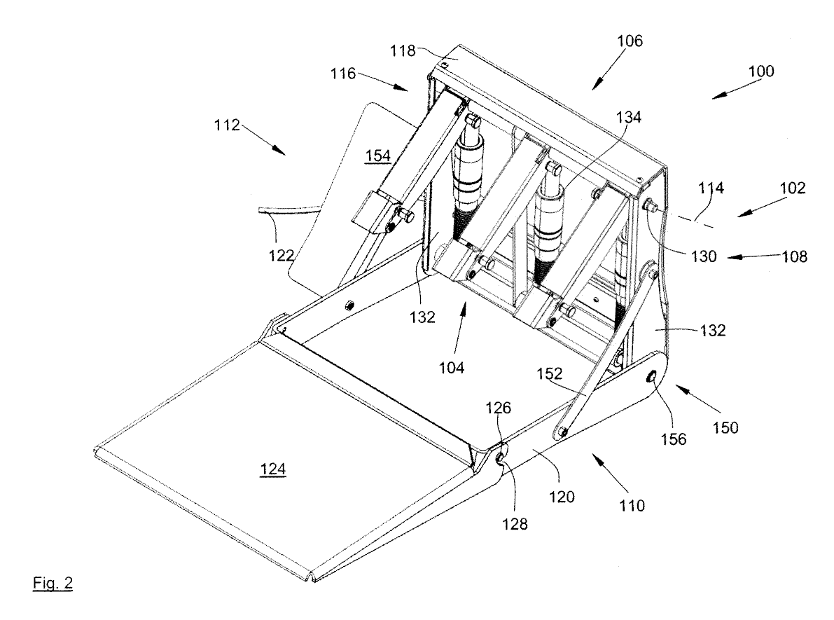

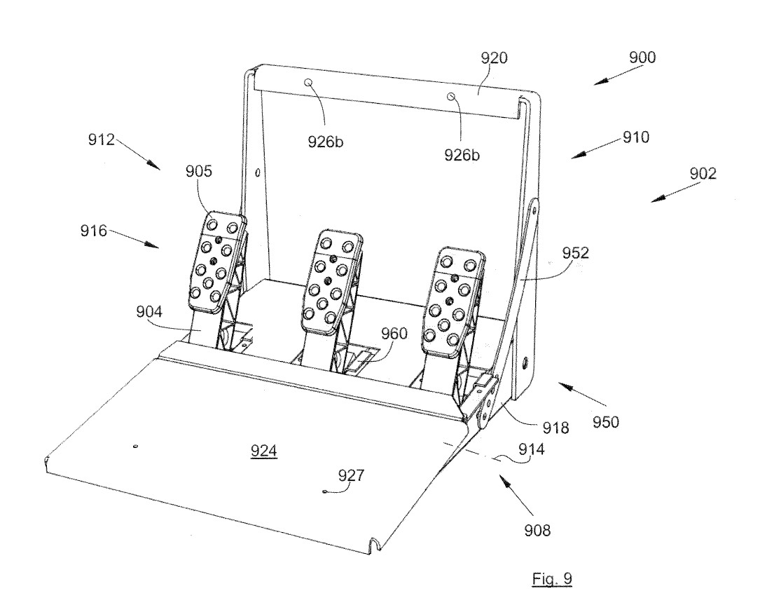

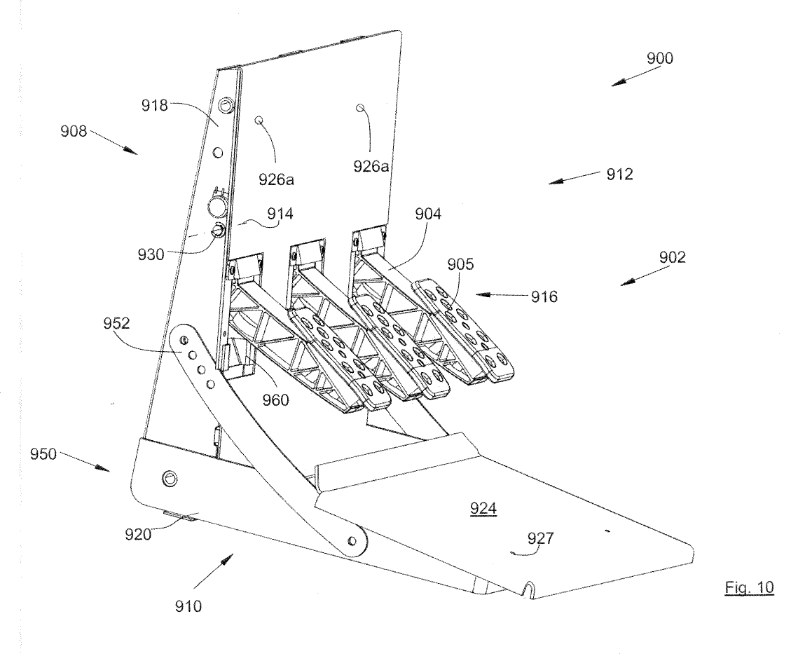

In the following description, the terms related to position refer to a pedal set in the user position, i.e. in the first position represented in FIG. 1 and in FIG. 9, or in the second position represented in FIG. 2 and in FIG. 10.

FIG. 1 shows a pedal set 100 for video games or for driving simulation according to a first embodiment of the invention in a first user position and FIG. 2 shows the same pedal set 100 in a second user position.

The pedal set 100 is composed of:

a frame 102 with a roughly triangular shape,

at least one lever arm 104 which has the ability to move in rotation on the frame 102 in one of the corners 106 of the triangle, and

for each lever arm 104, a pedal head (not represented) presenting a supporting area for at least one foot.

The frame 102 presents three sides 108, 110 and 112, two of these sides 108 and 110 are intended for positioning on the ground and each correspond to a stable user position of the pedal set 100 (each position is stable under gravity provided that the ground is horizontal).

Each pedal 116 is thus made up of a lever arm and a pedal head.

A stable position is a position in which a player using the pedal set 100 does not need to secure the pedal set 100 to be able to use it. The geometry of the pedal set 100 is such that the pressing on the pedals 116 does not lead to any movement of the frame 102 of the pedal set 100 under the forces to which the pedals 116 are submitted.

Sides 108 and 110 which correspond to the two user positions of the pedal set 100 lie on the floor and whatever the position of the pedal set 110, the centre of gravity of the pedal set 100 is above the side 108, 110 which is used as seen in FIGS. 1 and 2. Moreover the frame 102 supports the user's heel(s).

Pedal set 100 thus remains under the player's feet and does not run the risk of falling on his feet, unlike a pedal set that is attached under a support when the pedals are suspended and that could fall on the user's feet.

The first position is such that for the pedal or each pedal 116, the rotational axis 114 is at the lower end of the pedal 116 and therefore of the lever arm 104, and the second position is such that for the pedal or each pedal 116, the rotational axis 114 is at the upper end of the pedal 116 and therefore of the lever arm 104.

All that is therefore necessary is to turn the pedal set 100 to move from a stable user position of the pedal set 100 to another. There is no need for any tools.

In fact, to change the pedal set 100 from a stable position while the first positioning side 108 is being supported on the ground or on the pedal set support (the pedal set being now placed or secured on the ground), all that is necessary is to pivot the pedal set 100 around an axis that is roughly parallel to the rotational axis of the pedals 116 of the pedal set 100 until its second positioning side 110 is being supported on the ground or on the pedal set support, then, pivot the pedal set 100 to an angle of a 180 degrees around an axis that is roughly at right angles with respect to the ground surface or the pedal set support surface, and then reassign the function of the pedals 116 according to the position of the pedal set 100 using the selector described below.

A process for changing the position of the pedal set 100 thus comprises:

a step where the pedal set 100 pivots around an axis that is roughly parallel to the rotational axis of the pedal or each pedal 116 so as to change from the first stable position, i.e. the position supported on the first side 108, to the second stable position, i.e. the position supported on the second side 110, and

a step where the function of the pedal or at least one of the pedals 116 is reassigned, which will be explained below.

To reorient the pedal set 100, if necessary, the process for changing position also comprises a step where the pedal set 100 pivots around an axis that is roughly at right angles to the surface of the floor or the pedal set 100 support, in other words, at right angles to side 110,110 being supported.

This process can be reversed to position the pedal set 100 on the first positioning side 108.

Thus, the pedal set 100 comprises at least one pedal 116 which is able to move in rotation with respect to the frame 102 and the first stable position is that in which, seen from the left of the pedal set 100, the pedal or each pedal 116 pivots anticlockwise under the force produced by at least one foot to activate the pedal 116, and the second stable position is that in which, seen from the left of the pedal set 100, the pedal or each pedal 116 pivots clockwise under the force produced by the foot or feet to activate the pedal 116.

As explained below, the supporting area of the pedal or each pedal 116 is, in each position, laid out in such a way as to be positioned roughly at the level of the metatarsal of the foot.

As can be seen in FIG. 1, when the pedal set 100 is in the first stable position, the pedal head 116 is above its rotational axis 114 and the lever arm 104 is extended from the rotational axis 114 to the rear of the pedal set 100, i.e. the free end of the lever arm 104 moves away from the position where the player's foot is.

As can be seen in FIG. 2, when the pedal set 100 is in the second stable position, the pedal head 116 is below its rotational axis 114 and the lever arm 104 is extended from the rotational axis 114 to the front of the pedal set 100, i.e. the free end of the lever arm 104 moves towards the position where the player's foot is.

The outline of the frame 102 is preferably roughly that of an isosceles triangle. Sides 108 and 110 are almost the same length (the difference in length makes it possible to fold the frame 102 to facilitate storage) as described below.

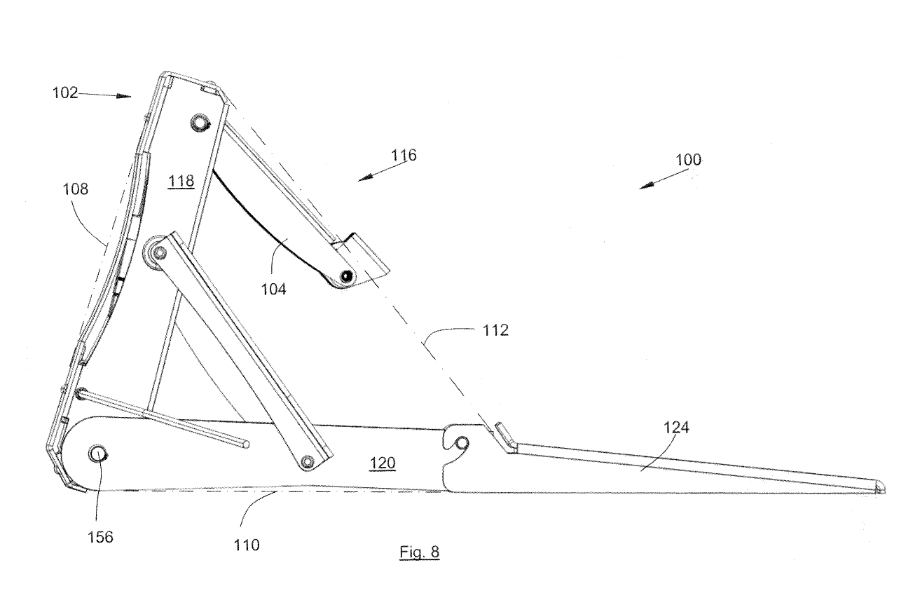

FIG. 8 shows the pedal set 100 in the second user position.

So that the user is comfortable, whether the pedal set 100 is in the first position or in the second position, the supporting area of the pedal head or each pedal head is, in each position, laid out in such a way as to be positioned roughly at the level of the metatarsal of the user's foot.

The supporting area is roughly laid out at the bisector of the angle formed by the intersection of sides 108 and 110.

The supporting area of the pedal head or each pedal head is, in each position, laid out roughly near the middle of the third side 112 which is not delimited here by mechanical elements.

The supporting area of the pedal head or each pedal head remains at a height with respect to the ground that is roughly equal, whether the pedal set 100 is in the first position or in the second position. However, this height may be adjusted, for example, by changing the inclination of the pedal head.

The distance between the supporting point of the user's heel and the supporting point in the supporting area of the pedal head is equal to 190 mm (+ or −25 mm).

The frame 102 thus presents a first part 118 which has one of the two positioning sides 108 and the pedals 116.

The frame 102 thus presents a second part 120 attached to the first part 118 and which holds the other positioning side 110.

The positioning of the first part 118 and the second part 120 is thus that of an open triangle, in other words, an L.

The third side 112 is delimited by the ends of the first part 118 and the second part 120.

The supporting area which is roughly at the end of the level arm 104 is in the interior angle formed by the branches (or arms) of the L or by the plans corresponding to the positioning sides 108, 110.

The supporting area is equidistant from the edges of the third side 112, i.e. from the ends of the first part 118 and the second part 120, i.e. the inside of the L.

The pedal set 100 comprises means of detection which make it possible to detect for each pedal 116 when the pedal 116 is activated, in other words, when the user presses pedal 116.

The pedal set 100 also has a control unit which receives the information from the detection means and transmits it to the central unit, for example, a computer or a video game console, to interact with the video game being executed by the central unit or by a networked gaming platform. This transmission takes place by an electrical cable 122 or by wireless connection.

Pressing each pedal 116 leads to a specific interaction with the video games, and turning the pedal set 100 leads to inversion of the position of the pedals 116 with respect to the user. For example, the clutch pedal becomes the accelerator pedal and vice versa. To overcome this disadvantage, a selector makes it possible to reassign the pedals 116 according to the position of the pedal set 100.

In the case of a pedal set 100 with three pedals 116, the function of the central pedal 116 remains classically unchanged.

The selector is a manual switch, for example. However, preferably, the selector is a gravity detector which delivers different electrical values depending on whether the pedal set 100 is in the first position or the second position.

Reading of the electrical value by the control unit makes it possible to reassign the pedals 116.

The selector could also consist of a software selector, such as, for example, an icon displayed on a viewing screen connected to the central unit and which can be selected, for example, using a mouse connected to the central unit. Selecting the icon then makes it possible to reassign the pedals.

This selector may or may not be integrated in a video game or vehicle driving simulation software program. In particular, the selector is integrated in a graphic interface of the software program and, for example, it comprises several icons each representing one of the positions of the pedal set 100 and all the user of the pedal set 100 has to do is to activate an icon corresponding to the position of the pedal set 100 for the software to reassign the pedals according to their position on the activated icon and therefore their effective position.

To guarantee that the pedal set 100 is correctly maintained on the ground, that the user's foot is well supported on the floor and that the user is comfortable, a footplate 124 is fitted to the frame 102, in a way that can be detached, along the extension of side 108, 110 resting on the ground and this is possible in one of the positions or both positions. The footplate acts as a heel rest for the user's feet and as a weight to preserve the balance of the pedal set 100.

Of course, depending on how the frame 102 is produced, the footplate 124 can be attached in a different way, such as, for example to the first part 118 or to the second part 120 depending on the user position as explained below for another embodiment of the invention.

The footplate 124 can be attached in different ways such as, for example, by screws. In the embodiment of the invention presented here, the frame 102 has studs 126 and the footplate 124 has indentations 128 in which these studs 126 are housed.

Each lever arm 104 has the ability to move in rotation on a main shaft 130, the axis 114 of which is horizontal and which is fitted between two side rails 132 which belong to the first part 118 of the frame 102. The ends of the main shaft 130 form studs and the indentations 128 of the footplate 124 can be housed there.

To guarantee the return to neutral position of each pedal 116, the pedal set 100 comprises for each lever arm 104, a springback system 134 which repositions the lever arm 104 in its neutral position when no pressure is exerted on it.

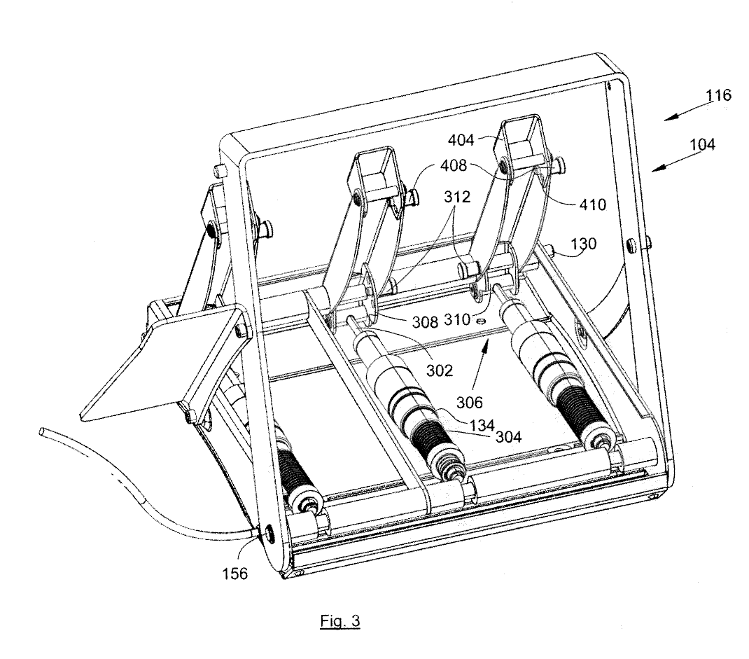

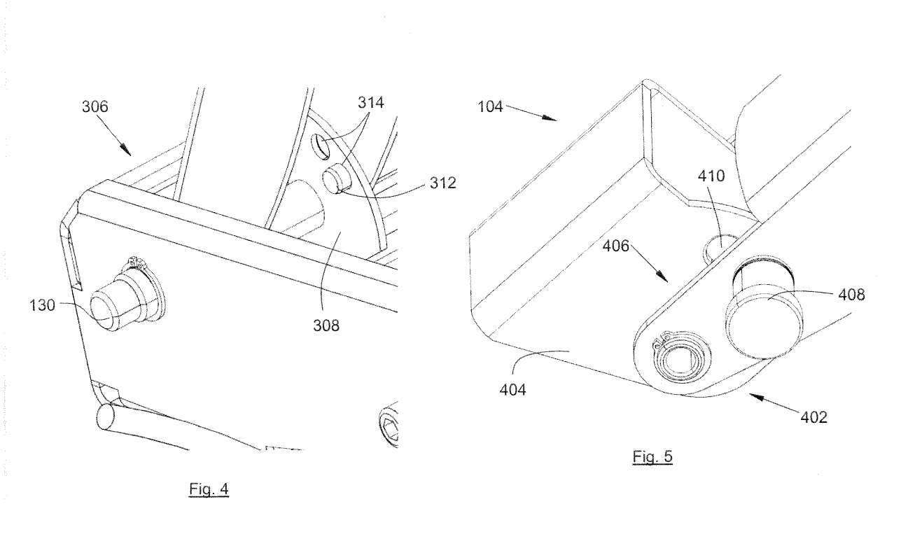

FIG. 3 and FIG. 4 show the attachment of the springback system 134 to a pedal 116.

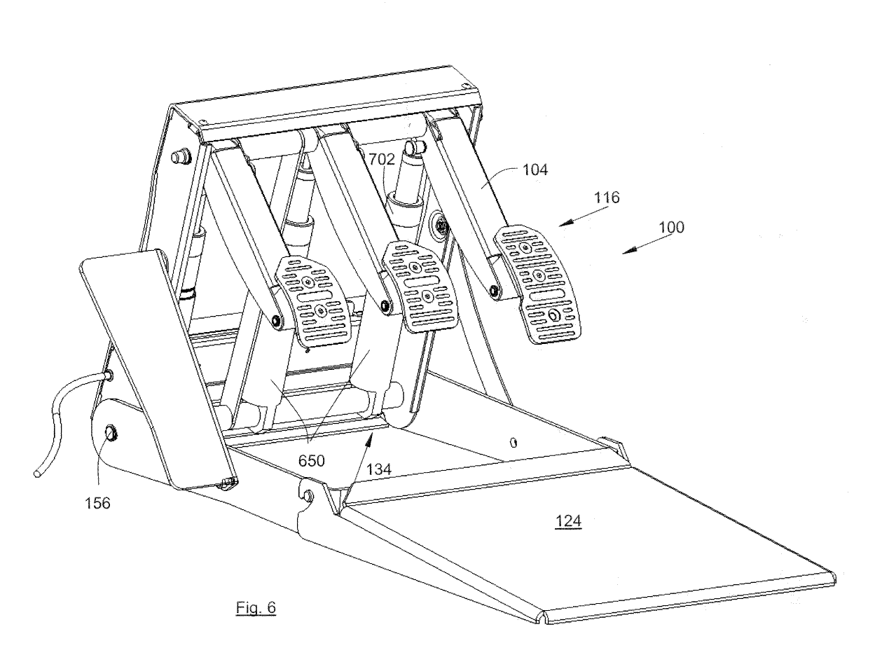

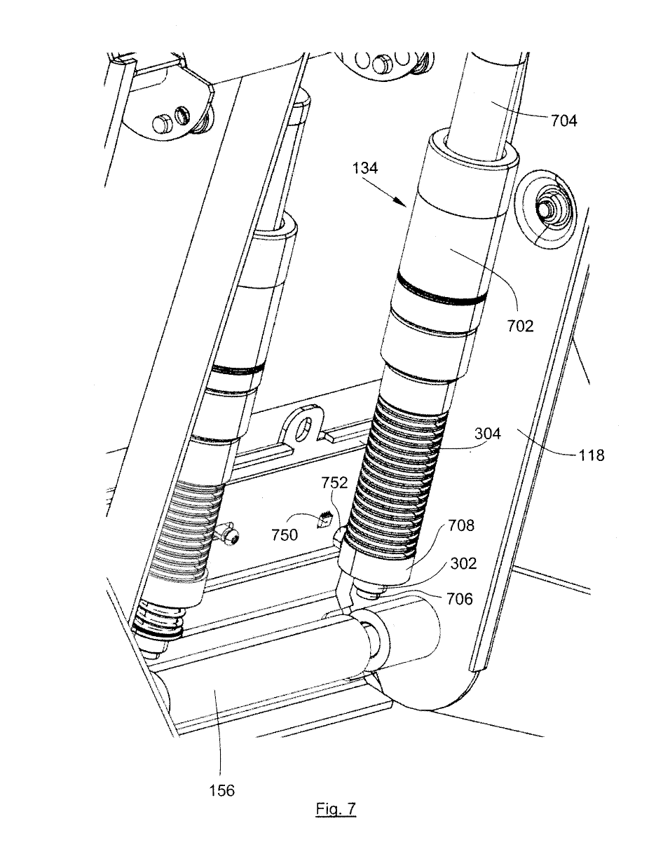

FIG. 6 and FIG. 7 show the elements of the springback system 134 and the assembly of the springback system 134 on the frame 102.

The springback system 134 is here made up of a rod 302 which is attached at one end to a secondary shaft 156 of the frame 102 and at the other end to the lever arm 104 of the pedal 116 in question, and a series of Belleville washers 304 is threaded along the rod 302.

The springback system 134 is a sort of elastic cylinder system and it is mainly made up of the rod 302 which holds the Belleville washers 304, a pull adjustment thumbwheel 702, an end-of-travel stop 704 and a connecting part 650 between the pull adjustment thumbwheel 702 and the secondary 156 shaft of the frame 102.

The rod 302 has a flange from one of the ends of the rod 302 along part of the length of the rod 302. One end of this rod 302 is connected to the lever arm 104 of the pedal 116 by means of an intermediate adjustment device 306 (FIG. 3). The other end, that of the flange, has a coaxial hole. Near this end there is a groove.

An elastomer stop 706 is fitted to and projects beyond the coaxial hole. This stop 706 may be coaxial and have a diameter that is smaller than that of the rod and therefore a diameter smaller than the flange diameter.

An elastomer ring is fitted to the rod 302 at the part with the smallest diameter and it is fitted as a stop against the flange.

A lock ring is fitted a short distance away from the end of the rod 302 which comprises the flange in the groove laid out in the flange.

A thick incompressible ring 708 is threaded along the rod 302, on the flange, i.e. on the part with the largest diameter and comes to a stop against the lock ring. The series of Belleville washers 304 is threaded along the flange of the rod 302.

The pull adjustment thumbwheel 702 is then threaded along part of the length of the flange of the rod 302. This pull adjustment thumbwheel 702 is coaxial with the rod 302 and the flange of the rod 302 can slide into this pull adjustment thumbwheel 702.

The series of Belleville washers 304 is sandwiched between the incompressible ring 708 (which is fixed due to the presence of the lock ring) and the pull adjustment thumbwheel 702.

The end-of-travel stop 704 is threaded on the rod 302 on the part that does not include the flange. This end-of-travel stop 704 is connected to the pull adjustment thumbwheel 702. One end of the end-of-travel stop 704 is threaded and penetrates the end of the pull adjustment thumbwheel 702 which is opposite the Belleville washers 304.

It is possible to screw the pull adjustment thumbwheel 702 more or less into the end-of-travel stop 704 to define the range of movement of the rod 302. In fact, screwing the end-of-travel stop 704 more or less into the pull adjustment thumbwheel 702 adjusts the distance between the end-of-travel stop 704 and the flange of the rod 302 or the elastomer ring and this thus sets the maximum travel of the rod 302 between the elastomer ring which is fitted against the flange and the end-of-travel stop 704.

The springback system 134 is fitted to pivot around the secondary shaft 156 by means of the connecting part 650 which comprises a bore receiving the rod 302 and the Belleville washers 304 and part of the pull adjustment thumbwheel 702. It also comprises a bore penetrated by the secondary shaft 156 perpendicular to the rod 302. It is possible to screw the pull adjustment thumbwheel 702 more or less into the connecting 650 to pre-stress the Belleville washers 304 more or less.

When the user presses the pedal, the rod 302 is pulled by the lever arm 104 of the pedal but the pull adjustment thumbwheel is held by the connecting part 650, for example, there is a thread between the internal diameter of the connecting part 650 and the external diameter of the pull adjustment thumbwheel 702. The Belleville washers 304 are then compressed between the pull adjustment thumbwheel 702 and the incompressible ring 708. They then exert a force that opposes the movement of the rod 302. If the force exerted on the pedal 116 is sufficient, the rod 302 slides into the pull adjustment thumbwheel 702 and into the end-of-travel stop 704 until the elastomer ring which is fitted against the flange rests against the end-of-travel stop 704. When the pedal 116 is no longer pressed, the rod 302 moves in the opposite direction and the elastomer stop 706 which is fitted at the end of the rod 302 absorbs any shock against the bottom of the bore of the connecting part 650.

Regarding the brake pedal, its cylinder also has a spring that offers lower resistance on the first part of travel of the rod 302 and the Belleville washers 304 which offer higher resistance on the second part of travel of the rod 302.

The means of detection for detecting when the pedal 116 is activated consist of Hall-effect detection assemblies which measure the relative movement of a magnet attached to the rod 302 with respect to a Hall effect sensor 750 attached to the first part 118 of the frame 102. In the embodiment of the Figures, the pedal set 100 comprises three pedals 116. As a result, there are three rods 302 and three Hall effect sensors 750. A magnet 752 is fitted to the thick ring 708 of each rod 302. When the user activates a pedal 116, the rod 302 of its springback system 134 moves, as does the thick ring 708 and therefore the magnet 752 borne by this thick ring 708. The Hall effect sensor 750 allocated to this magnet 752 measures a variation in the magnetic field due to the movement of this magnet 752. From this measurement, the control unit deduces the information related to the movement of the magnet 752 with respect to the Hall effect sensor 750, especially the movement distance, the movement direction and the movement speed. As magnetic fields penetrate the material, it is possible to place a hood above the Hall effect sensors 750 and the control unit to protect them and the Printed Circuit Board (or PCB) to which they are welded (the PCB is screwed to the first part 118 of the frame 102). FIG. 2 represents the pedal set 100 with a protective hood screwed above the printed circuit board.

To provide angular adjustment of the pedal 116 and therefore of the lever arm 104, the attachment between the rod 302 and the lever arm 104 takes place by means of an intermediate adjustment device 306. The intermediate adjustment device 306 has a clevis 308 which is able to move in rotation around the main shaft 130 of the frame 102 and an adjustment axis 310 parallel to the main shaft 130 and moving in rotation on the clevis 308.

The rod 302 of the springback system 134 is attached to the adjustment axis 310.

The intermediate adjustment device 306 also has locking means that lock the position of the lever arm 104 and therefore of the pedal 116 with respect to the clevis 308.

The locking means (or locking device) are in the form of a retractable pin 312 and a series of at least two holes 314. The lever arm 104 carries the spring-mounted retractable pin 312 and the clevis 308 presents the series of holes 314 intended to receive the retractable pin 312.

To adjust the angle, the user retracts the retractable pin 312 by pulling on it to remove it from hole 314 in which it is located, then he turns the lever arm 104 to align the retractable pin 312 with another hole 314, then he releases the retractable pin 312 which enters the other hole 314 through the action of the spring.

FIG. 5 shows a detail drawing of the free end of a lever arm 104.

To allow the pedal head to be positioned correctly in accordance with the player's wishes, the pedal 116 comprises, near the free end of the lever arm 104, an intermediate adjusting mechanism 402 to which the pedal head is attached.

The intermediate adjusting mechanism 402 comprises a clevis 404 which is able to move in rotation at the free end of the lever arm 104 and an attachment device 406 which fixes the position of the clevis 404 with respect to the lever arm 104.

The pedal head is fitted to the clevis 404. The shape of the pedal head may be symmetrical to avoid pivoting it when the user changes the position of the pedal set 100.

The attachment device 406 takes a similar form here to that of the previous locking device. The lever arm 104 carries a retractable pin 408 and the clevis 404 presents a series of at least two holes 410 intended to receive the retractable pin 408.

To facilitate storage of the pedal set 100, the corner 150 between the two positioning sides 108 and 110, forms a hinge. In other words, the first part 118 and the second part 120 are fitted together by means of a hinge.

To facilitate storage, each pedal 116 must be folded towards the inside of the frame 102, in other words, to the inside of the first part 118, here between the two side rails 132. This storage is possible due to the intermediate adjustment device 306 which comprises a hole 314 dedicated to this storage.

To maintain the pedal set 100 in the user position, at least one small connecting rod 152, hereinafter known as a “spacer”, attached, in a way that can be detached, for example using screws, is fitted between the first part 118 comprising the positioning side 108 and the second part 120 comprising the positioning side 110.

The spacer or one of the spacers 152 may be replaced by a footrest 154.

FIG. 9 shows a pedal set 900 for video games according to a second embodiment of the invention in a first user position and FIG. 10 shows the same pedal set 900 in a second user position. The process for changing the position of the pedal set 900 is similar to that presented above for the pedal set 100 in the first embodiment of the invention.

The pedal set 900 is composed of:

a frame 902 with a roughly triangular shape

at least one lever arm 904 which has the ability to move in rotation with respect to the frame 902, and

for each lever arm 904, a pedal head 905 presenting a supporting area for at least one of the user's foot.

As for the first embodiment of the invention, the frame 902 presents three sides 908, 910 and 912, two of these sides 908 and 910 are intended for positioning on the ground and each correspond to a stable user position of the pedal set 900.

As for the first embodiment of the invention, the pedal set 900 is such that the first stable position is that in which, seen from the left of the pedal set 916, the pedal or each pedal 900 pivots anticlockwise under the force produced by at least one foot to activate the pedal 916, and the second stable position is that in which, seen from the left of the pedal set 900, the pedal or each pedal 116 pivots clockwise under the force produced by the foot or feet to activate the pedal 916.

Each pedal 916 is thus made up of a lever arm 904 and a pedal head 905.

To allow better adjustment of the pedal head 905 to the user's foot or feet, the pedal head 905 may comprise a detachable head support 907 which can be replaced by a different head support. The head support 907 makes it possible to modify, for example, the inclination of the pedal head 905 with respect to the lever arm 904.

The head support 907 is thus positioned between the lever arm 904 and the pedal head 905 and it makes it possible to modify the inclination of the pedal head 905 and the height of the pedal head 905 with respect to the lever arm 904.

Movement from one stable position to another stable position requires 180° rotation of the pedal head 905 and the head support 907. To do this, simply unscrew the screws retaining the pedal head 905 and the head support 907.

The head support 907 comprises a flat surface that comes into contact with a flat part of the lever arm 904 and a rounded surface on which the pedal head 905 rests.

The flat part of the lever arm 904 may comprise several series of holes that make it possible to select the screwing position of the pedal head 905 and the head support 907 on the lever arm 904 thus making it possible to adjust, on the one hand, the height of the head support 907 and therefore the pedal head 905 with respect to the lever arm 904, and, on the other hand, the cross-position of the pedal head 905 with respect to the lever arm 904 and therefore the spacing between the pedal heads 905.

Of course, other adjustment systems may be installed.

The first position is such that for the pedal or each pedal 916, the rotational axis 914 is at the lower end of the pedal 916 and therefore of the lever arm 904, and the second position is such that for the pedal or each pedal 916, the rotational axis 914 is at the upper end of the pedal 916 and therefore of the lever arm 904.

It is therefore sufficient to turn the pedal set 900, so that the positioning side supported by the ground or a support, such as a cockpit, for example, is no longer the positioning side 908 but the positioning side 910, to move from one stable user position of the pedal set 900 to another.

FIG. 10 shows the pedal set 900 in the second user position.

The supporting area of the pedal head or each pedal head 905 is roughly laid out at the bisector of the angle formed by the intersection of the positioning sides 908 and 910.

The supporting area of the pedal head or each pedal head 905 remains at a height with respect to the ground (or the pedal set support) that is roughly equal, whether the pedal set 900 is in the first position or in the second position, as long as the pedal head pivots on an angle of 180 degrees.

So that the user is comfortable, whether the pedal set 900 is in the first position or in the second position, the supporting area of the pedal head or each pedal head 905 is, in each position, laid out in such a way as to be positioned roughly at the level of the metatarsal of the user's foot. If the supporting surface is small, for example in the event of using a small pedal head, the supporting area of the pedal head or each pedal head 905 is, in each position, laid out in such a way as to be positioned roughly at the level of the head of the metatarsal bones.

As for the first embodiment of the invention, the supporting area which is roughly at the end of the lever arm 904 is laid out between the first part 918 and the second part 920, i.e. inside the triangle and inside the L formed by the first part 918 and the second part 920.

To improve user comfort, the pedal set 900 comprises a footplate 924 that can be attached, in a way that can be detached, to the frame 902 alternatively on the first part 918 in the first user position or on the second part 920 in the second user position. Thus, the supporting area of each pedal 916 is laid out between the two elements alternatively supporting the footplate 924, i.e. the frame of the first part 918 and the frame of the second part 920.

As a result, as for the first embodiment, the supporting area is in the interior angle formed by the branches of the L or by the plans corresponding to the positioning sides 908, 910.

The footplate 924 is used to rest the user's heels and it may have a non-slip surface to avoid the heels slipping.

The distance between the supporting point of the user's heel on the footplate 924 and the supporting point in the supporting area of the pedal head is equal to 190 mm (+ or −25 mm).

The frame 902 thus presents a first part 918 which has one of the two positioning sides 908 and the pedals 916.

The frame 902 thus presents a second part 920 attached to the first part 918 and which holds the other positioning side 910.

The third side 912 is roughly delimited by the ends of the first part 918 and the second part 920.

As for the first embodiment of the invention, the pedal set 900 comprises means of detection which make it possible to detect for each pedal 916 when the pedal 916 is activated.

The pedal set 900 also comprises a control unit which receives the information from the means of detection and transmits it to a central unit.

Turning the pedal set 900 leads to inversion of the position of the pedals 916 with respect to the user. For example, the clutch pedal becomes the accelerator pedal and vice versa. To overcome this disadvantage, a selector makes it possible to reassign the pedals 916 according to the position of the pedal set 900.

For example, the selector takes the same form as that used in the first embodiment of the invention.

The footplate 924 can be attached in different ways. In the embodiment of the invention presented here, the frame 902 has screw holes 926a and 926b into which the fastening screws 927 are screwed to attach the footplate 924.

In the embodiment of the invention presented here, there are two screw holes 926a made in the first part 918 and two screw holes 926b made in the second part 920. The first part 918 and/or the second part 920 may also have flat brackets and one screw is fastened in each of these flat brackets to ensure better fastening of the footplate 924. The footplate 924 may also have more than two screw holes.

The footplate 924 may be attached to different places in the first part 918 and the second part 920 in order to position it in the best way for the user, i.e. so that the distance between the user's heel and the pedal support area corresponds correctly to the size of the user's feet. To this end, the frame 902 may comprise screw holes distributed in different places to allow several positions for fastening the footplate 924.

The footplate 924 may have a crease and the different positions for the footplate 924 make it possible for a user to position this crease so that it guides his heel(s) or so that it does not come into contact with his heel and thus presents a free surface on which the heel(s) can move freely.

Likewise, the footplate may have a different shape. For example, it may have two creases and a cut separating these two creases. The first crease corresponds to the brake and accelerator pedals which are activated by the same foot and the second crease corresponds to the clutch pedal activated by the other foot.

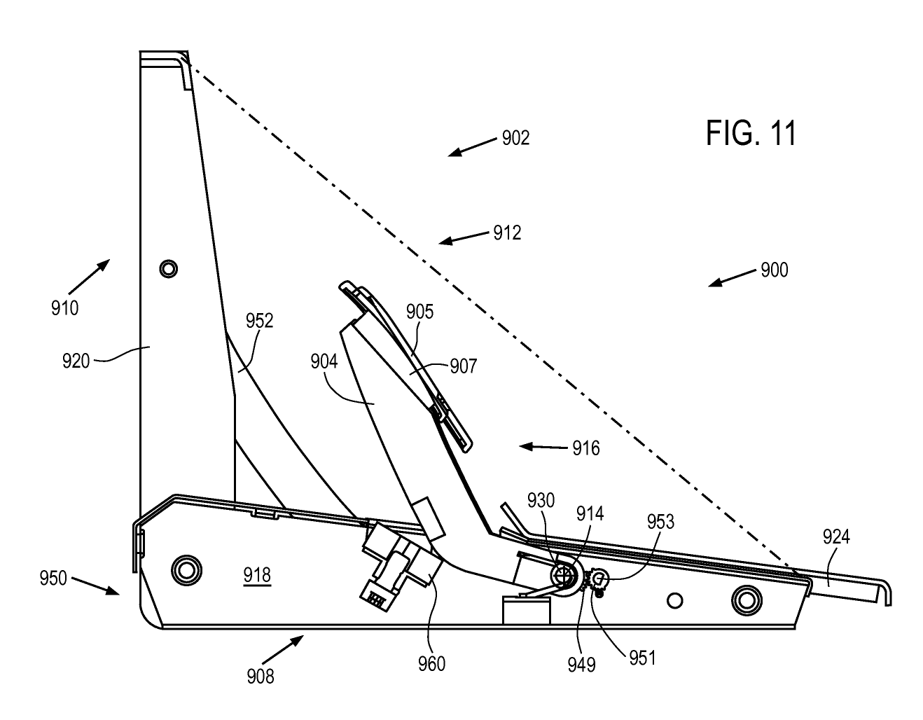

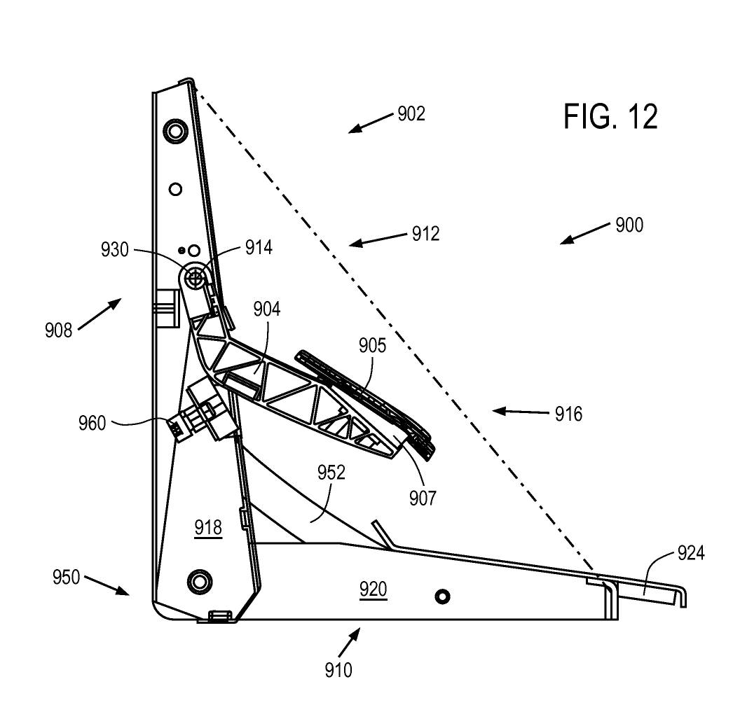

FIG. 11 and FIG. 12 show another method of operating the pedals 916, but it is possible to use the same mechanism as that used in the first embodiment of the invention.

Each lever arm 904 has the ability to move in rotation on the main shaft 930, the axis 914 of which is horizontal and which is fitted to the structure of the first part 918.

In the embodiment of the invention presented here, the first part 918 is made up of three identical modules which are attached to each other. Each module has a rigid structure and a pedal 916 attached to the rigid structure by its shaft 930.

To guarantee the return to neutral position of each pedal 916, the pedal set 900 comprises for each lever arm 904, a springback system 934 which here is made up of two torsion springs 934, the first arm of which is supported against a stop from the first part 918 and the second arm of which is supported against a stop from the lever arm 904.

The means of detection for detecting when the pedal 916 is activated consist here of a potentiometer 953 attached to the first part 918. In the embodiment of the invention presented here, a gear 951 is attached to the potentiometer 953 and a gear 949 is attached to the lever arm 904. The two gears 949 and 951 engage with each other. Thus, the rotation of the pedal 916 leads to the rotation of its gear 949 and therefore the gear 951 of the potentiometer 953 whose value varies as a result. Of course, it is possible to use means of detection similar to those used in the first embodiment of the invention.

To facilitate storage of the pedal set 900, the corner 950 between the two positioning sides 908 and 910, forms a hinge. In other words, the first part 918 and the second part 920 are fitted together by means of a hinge. It is thus possible to fold the frame 902 on the outside so that the pedal set 900 takes up less space. It is also possible to deliver the pedal set 900 with the pedals 916 pre-stressed so that the pedal set 900 takes up less space.

To maintain the pedal set 900 in the user position, at least one spacer 952, attached, in a way that can be detached, for example using screws, is fitted between the first part 918 comprising the positioning side 908 and the second part 920 comprising the positioning side 910.

Of course, as for the first embodiment of the invention, it is possible to provide, for each pedal 916, an intermediate adjustment device intended to allow angular adjustment of the pedal 916 similar to that of the first embodiment of the invention.

As previously indicated, the head support 907 makes it possible to modify the position of the pedal head 905 with respect to the lever arm 904. It is also possible to remove the head support 907 or to complete it with another intermediate adjustment device intended to adjust the pedal head 905 with respect to the lever arm 904.

FIGS. 9 to 12 also show for each pedal 916, a stop 960 which is attached to the frame 902 in a way that can be detached and which comprises a stop area on which the pedal 916 comes to a stop when it is activated by the foot.

The stop 960 is attached here by screws which can be removed. After removal of the screws, it is then possible to reverse the stop 960 and to support it against the lever arm 904 and refasten the screws. The pedal 916 is then pre-stressed by the stop 960 which improves the compactness of the pedal set 900 during storage, for example, in the delivery box.

In the operating position, the stop 960 can be adjusted so as to allow movement of the stop area along the pedal 916. The change of position of the stop 960 makes it possible to adjust the travel of the pedal 916 and its resistance to being pressed.

The movement of the stop 960 takes place along the frame 902.

Of course, this invention is not limited to the examples and embodiments described and represented, but it is susceptible to numerous variants that are accessible to a man skilled in the art.

The pedal head may be fitted to a rotating device for rotating the pedal head. The pedal head may be fitted to an intermediate plate pivoting around the clevis 404 and the clevis 404 may have a second locking device to lock the angular position of the pedal head with respect to the clevis 404 i.e. a retractable pin at right angles to the intermediate plate. The plate presents a series of at least two holes to receive the retractable pin. Given that the changeover from one stable position to another stable position may require 180° rotation of the pedal head, such a device for rotating the pedal head makes it possible to perform the rotation without using any tools.

The intermediate plate may be more or less thick to adjust the distance between the pedal head and the clevis 404 and therefore the lever arm 104.

Other means of detection may be used to detect when the pedal is activated.

Stress gauges may be fitted to the lever arm 104 of the pedal 116 to measure the forces exerted on the pedal 116.

For each pedal 116 in the case of the first embodiment, its springback system 134 may comprise a linear potentiometer fitted between its thick ring and its connecting part to detect movement of the thick ring and the data related to its translation with respect to the connecting part 650 and therefore with respect to the frame 102.

In a variant, the first part 118 and the second part 120 are not fitted together by means of a hinge, but they are fitted in such a way that they can be detached from each other. The second part 120 presents two indentations which house the ends of the secondary shaft 156 which penetrates the first part 118 parallel to the corner 150. For increased rigidity, these ends may be threaded and nuts, such as wing nuts may be used to hold the first part 118, in a way that can be reversed, to the second part 120.

Thus, it is possible to make provision for the second part 120, 920 being an additional element at is attached to the first part 118, 918. The first part 118, 918 thus guarantees one of the stable positions and the fitting of the second part 120, 920 makes it possible to create the second stable position.

To this end, the second part 120, 920 comprises means of attachment to the first part 118, 918. For example, the first part 118, 918 may comprise screw holes on the sides near the rear end and the second part 120, 920 may also have a screw hole near each of its ends. It is then sufficient to align the holes and attach a fastening screw. Retractable spring pins could also be used and fastened to one of the parts to be housed in appropriate holes in the other part.

Thus, in this embodiment, the frame 102, 902 is made up of the first part 118, 918 supporting the pedals 116, 916 and a second part 120, 920 which is fastened, in a way that can be detached, to the first part 118, 918.

Such an assembly makes it possible to facilitate storage and limits the space taken up when only the first stable position is used.

The second part 120, 920 may take the form of an arch or a support in the form of a bracket.

Whether or not the second part 120, 920 is detachable, it is in fact possible to provide for there to be several second parts 120, 920, each being attached, in a way that can be detached, to the first part 118, 918 or to another of the second parts 120, 920, or for there to be several second parts 120, 920, each being able to move in rotation with respect to the second part 118, 918 or with respect to another second part 120, 920.

The frame 102, 902 may have a different shape, depending on the number of parts 118, 120, 918, 920. It may have a rectangular profile with four parts, triangular with three or two as described above.

The different parts may constitute a folding frame and be held in place by tightening or by the fitting of spacers or brackets.

It is also possible to provide for one or both parties 118, 120, 918, 920 to be made up of at least two parts which are fitted together telescopically with respect to each other, i.e. they may slide into each other. In order to fit the parts together, blocking resources, such as screws (or retractable spring pins) and holes made in the different parts are fitted.

Of course, it is possible to provide for one or more supporting areas to be able to be activated by more than one foot. To this end, the pedal head may be increased to offer a large supporting area and it may be attached to one or two lever arms.

The pedal set 100, 900, according to the invention, has been described as resting on the ground, but it is also possible to provide for it being attached, in one position or another, to a cockpit reproducing all or part of the form of the simulated vehicle, or to a support dedicated to driving simulations made up of a driving simulation seat comprising a support for a steering wheel and a support for a pedal set.

As has been described above, the supporting area is inside the L formed by the first part 118, 918 and the second part 120, 920, but the dimensions of the first part 118, 918 and/or the second part 120, 920 could be such that the supporting area is situated outside the triangle, i.e. beyond the side 112, 912. For example, it is possible to reduce the dimensions of the frame 102, 902 and therefore the parts 118, 918, 120, 920 that make it up, but care must be taken so that when the user activates a pedal 116, 916, the end of the user's foot overhanging the pedal, i.e. the toe, does not touch the part of the frame 102, 902 that is not the part on which the heel is resting. To do this, it is possible to increase the angle between the sides 108, respectively 908 and 110, respectively 910, making this angle more than 90 degrees. To do this, the anchor points of the spacers 152, 952 on the frame 902 make it possible to position them so that they maintain the angle required between the first part 118, 918 and the second part 120, 920. To preserve the balance of the pedal set 100, 900, a weight may be fitted, in a way that can be detached, to the frame 102, 902 and/or to the footplate.

It is possible to add an inclining mechanism that makes it possible to adjust the inclination of the frame 102, 902 with respect to the ground. This inclining mechanism may consist of two feet extending longitudinally with respect to the frame 102, 902 and fastened by screws on the sides of the frame 102, 902, either on the sides of the first part 108, 908, or on the sides of the second part 120, 902.

The two feet could be replaced by just one foot.

The two feet could be replaced by two cylindrical feet with screws that can be screwed into various alternative sites according to the direction of inclination and the position of the pedal set.

A U-shaped arch could also be provided, with holes along the sides and which could be fitted to pivot, in a way that can be detached, around the rear cross-shaft or the front cross-shaft and two additional small connecting rods (or spacers) with holes maintaining the arch in the required position.

There could also be the addition of a horizontal plate in contact with the ground and fitted to pivot around one of the cross-shafts of the frame and one or more arms, one of the ends of which pivots with respect to the plate and the other end of which works in conjunction with one of several cylindrical rings fitted under the frame. A short shaft and a pin, both of which are detachable, make it possible to avoid this end of the arm becoming detached from its cylindrical ring.

A sliding system could also be envisaged, fastening either behind the frame or at the sides of the frame and comprising one or more spring-mounted retractable pin(s) in a first element of the sliding system and one or more series of holes made in other element(s) of the sliding system and intended for receiving the spring-mounted retractable pins in such a way as to maintain the sliding system in the required position and therefore with the required inclination.

To protect the pedal set and the elements that do not have to be manipulated in normal operation, such as, for example, the potentiometer 953, a fairing cover plate, preferably detachable and partially planed to replace a footplate at least in one of the stable positions of the pedal set is fitted to the frame 102, 902.

This cover plate is represented in FIG. 9 with the reference 962 and it can have one or more crease(s) similar to those of the footplate 124, 924.

What is claimed is:

1. A pedal set for video games or vehicle driving simulation, the pedal set comprising:
a frame; and
at least one pedal which has the ability to move in rotation with respect to the frame, the pedal or each pedal having a supporting area for at least one foot,
said pedal set being characterised in that said frame is designed to take alternatively at least two stable positions on the floor or a support:
a first stable position, in which seen from the left of the pedal set, said pedal or each pedal pivots anticlockwise under the force produced by said at least one foot to activate the said pedal,
a second stable position, in which seen from the left of the pedal set, said pedal or each pedal pivots clockwise under the force produced by said at least one foot to activate the said pedal, and
wherein the supporting area of the pedal or each pedal is, in each position, laid out in such a way as to be positioned roughly at the level of the metatarsal of at least one foot.

2. The pedal set according to claim 1, characterised by the fact that said frame is made up of a first part supporting the pedal or pedals and at least one second part, the or each second part being fastened, in a way that can be detached, to the first part or to one of the other second parts.

3. A pedal set according to claim 1, characterised by the fact that said frame is made up of a first part supporting the pedal or pedals and at least one second part, the or each second part having the ability to move in rotation with respect to the first part or to one of the other second parts.

4. A pedal set according to claim 2, characterised by the fact that there is only one first part and one second part which are fitted together in an L-shape and the pedal supporting areas are laid out inside the branches of the L.

5. A pedal set according to claim 3, characterised by the fact that the rotation is carried out by a hinge between the first part and the second part or each of the second parts.

6. A pedal set according to claim 2, characterised by the fact that it comprises at least one spacer fastened, in a way that can be detached, between the two parts to hold them in position with respect to each other.

7. A pedal set according to claim 2, characterised by the fact that each part presents a positioning side, each one being designed to be positioned on the ground or on a support and each corresponding to a stable position of the pedal set.

8. A pedal set according to claim 1, characterised by the fact that it comprises a selector making it possible to reassign at least one of the pedals according to the position of the pedal set.

9. A pedal set according to claim 8, characterised by the fact that the selector is a gravity detector.

10. A pedal set according to claim 1, characterised by the fact that it comprises, for the pedal or each pedal, an intermediate adjustment device intended to allow angular adjustment of the pedal, the intermediate adjustment device comprising a clevis with the ability to move in rotation with respect to the frame, an adjustment axis with the ability to move in rotation on the clevis and locking means that lock the position of the pedal with respect to the clevis, these locking means taking the form of a retractable pin set on the pedal, and a series of at least two holes made in the clevis and intended to receive the retractable pin.

11. A pedal set according to claim 1, characterised by the fact that the pedal or each pedal is made up of a lever arm, a pedal head comprising the supporting area and an intermediate adjusting mechanism attached, on one side, to the lever arm, and, on the other side attached to the pedal head and intended to adjust the pedal head with respect to the lever arm.

12. A pedal set according to claim 1, characterised by the fact that it comprises, for the pedal or each pedal, a stop attached to the frame in a way that can be detached, and comprising a stop area against which the pedal comes to a stop when it is activated by at least one foot or when the stop pre-stresses the pedal.

13. A pedal set according to claim 12, characterised by the fact that the position of the stop can be adjusted so as to allow movement of the stop area along the length of the pedal.

14. A second part comprising means of attachment to a first part of a pedal set according to claim 2.

15. A process for changing the position of a pedal set according to claim 1, the process comprising:
a step where the pedal set pivots around an axis that is roughly parallel to the rotational axis of the pedal or each pedal so as to change from one stable position to another stable position, and
a step where the function of the pedal or at least one of the pedals is reassigned.

16. A process for changing position according to claim 15, characterised by the fact that it also comprises a step where the pedal set pivots around an axis that is roughly at right angles to the surface of the floor or the pedal set support.
